(19) United States
(12) Patent Application Publication
(10) Pub. No.: US 2023/0042143 A1
(43) Pub. Date: Feb. 9, 2023

(54) ILLUMINATION SAFEGUARD ADAPTER FOR OUTSIDE WALL LIGHTING FIXTURES WITH BODY THAT EXTENDS BEYOND LIGHT BULB TO MAINTAIN LIGHT TRANSMISSION WHILE REDUCING VERTICAL LIGHT POLLUTION

(71) Applicant: Hunter Liam Spallas, Tucson, AZ (US)

(72) Inventor: Hunter Liam Spallas, Tucson, AZ (US)

(21) Appl. No.: 17/367,404

(22) Filed: Aug. 4, 2021

(51) Int. Cl. F21V 29/83; F21K 9/235; F21V 29/508

(52) U.S. Cl. CPC F21V 29/83; F21K 9/235; F21V 29/508

(57) ABSTRACT

A unique outdoor lantern bulb adaptor includes a module that extends beyond the bulb to maintain light output while reducing vertical light pollution. The adapter is IDA compliant and manufactured with a non-shattering UV resistant thermoplastic unit installed via a standard light bulb screwing mechanism without the need for any additional bracket or mounting system. An adapter consisting of an outer standard light bulb cover with vents to maintain light output while also being easily removed, replaced, and transported.

### SPECIFICATION

The unique invention described in this patent application is described as an outdoor lighting fixture adapter with a body that extends beyond the length of the light bulb to both maintain light transmission and reduce vertical light pollution. The entire invention consists of a singular injection-molded body, already included with adaptable interface features such as the light bulb base tightening mechanism and twelve dissipating heat vents. The invention is an injection molded thermoplastic being both UV-resistant and temperature-change resistant. An outer coat may or may not be applied during or after the molded process to ensure material properties and adapter longevity over long periods of time. Handling and using the described invention is greatly simplified when compared to existing models out on the market. The user correctly orients the adapter module so that the bulb base cut is facing upwards, while the openings of the vents are pointed downward. The user places a standard light bulb (recommended CFL or LED) of their choice inside of the adapter so that the bulb base fits into the cut on the top. At this point the only visible part of the light bulb should be the bulb base extruded at the top of the adapter. Once the entire light bulb is securely fastened into the adapter with the entire light bulb enclosed inside, then the user moves the light bulb adapter combination into the desired lighting fixture. The user then fastens the light bulb adapter combination into the proper lighting fixture bulb socket until it is secured in place. The interface between the light bulb base and the light fixture bulb socket securely holds the light bulb adapter in place while also ensuring a strong electrical connection to be able to turn on and off the lighting fixture.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

Asteroid detection telescopes are extremely important in being able to detect and predict the paths/orbits of asteroids to avoid catastrophic disaster on Earth. Unlike the majority of telescopes that have a narrow field of view and high magnification, survey telescopes have a wide field of view to scan the entire sky in a reasonable amount of time with enough sensitivity to pick up the faint near-earth-objects they are searching for. This process can be hindered depending on the amount of stray light casted upwards by the cities/homes below. Light pollution causes a considerable amount of glare effect on these telescopes, preventing them from being able to detect smaller asteroids. If any asteroids were able to pass by the detection system undetected due to unwanted glare, the safety of the people below would become a main concern. In terms of a Utility patent, the existing known forms of prior art that resemble the functionality and purpose of what is presented in the current application are listed in the following section. Currently, there is not any known art that discloses a fully vented and mount-less extendable adapter that is acceptable under International Dark Sky Association (IDA) standards. The lumen standards set by the IDA are current as of May 20, 2021. The novel invention described in this application qualifies under IDA standards, preventing any considerable vertical upward transmission, as described below. Many varieties of wall-mounted house lights and light shields are currently available in the marketplace. Some of the known current patent-pending light shields/shades on the market are limited to fitting in specific lamps due to their complex geometries/mounting systems and they do not allow for approved heat dissipation due to the lack of a proper venting system. Some light shields still allow light transmission in a 360-degree ring and therefore cannot be accepted under the IDA standards. If a consumer has purchased an external wall-mounted house lamp with the desire to allow light transmission over a 360 degree ring but would like to limit their fixture's transmission (lux) later on, then the only other solution would be to purchase a completely new lamp or settle for a light shield that becomes semi-permanent and difficult to remove once installed. The current known patent-pending light shield designs on the market have potential to result in safety hazards that occur from trapping light bulb heat output in a very confined space. The current unique invention described in this application is the solution to this in the form of an adaptable, light weight, and easily removeable light shield, capable of being integrated with most, if not all, home light lamps that use the standard light bulb (recommended CFL or LED). The light bulb shield described in this application consists of: (1) Universal bulb-fitting cylinder; with (2) illumination heat vents to permit the highest allowable transmission while appropriately dissipating heat energy. The parts and accessories include an adaptable hollow cylinder-shaped vented body fitted to the standard light bulb (recommended CFL or LED). A list of the main features of the current invention is thus the provision of (1) a sealed top piece that restricts no more than fifty (50) lumens of light transmission from travelling upwards; (2) a circular opening on the top of the hollow body perfectly fitted to support a variety of standard light bulbs; (3) illumination vents on the cylinder body directing light transmission downwards while still allowing a desired lux output; and (4) a durable, temperature-resistant, UV-resistant, light-weight thermoplastic-based material manufactured to withstand hot summers and cold winters over long periods of time.

### BRIEF SUMMARY OF THE INVENTION

The invention described in this application may appear to be similar to a variety of lighting adapters on the market, however, there are many advantages to this invention when compared to the competition. The existing problems, as stated and explained in the “Background of the Invention” section, are problematic for both the convenience of the user and their safety. The simplified design of the adapter described in this application makes it much simpler for the user to install in a very short amount of time. No external tools or screws are needed to properly secure the adapter in place, reducing the hassle that the user has to go through. The entire installation process of this invention can take less than a minute and is just as securely held in place as is the competitions' light shields which require a mounting bracket or some other complement in addition to their adapter. One of the problems that this invention solves is the convenience issue. External tools are not necessary and the user only needs about a minute to receive the full benefit and utility of this adapter.

Another problem described further in the “Background of the Invention” section, is the issue associated with heat dissipation. Depending on the type of light bulb used, light bulbs can reach an external surface temperature of around 250 Degrees Fahrenheit. Enclosing this much heat energy in a tight-fitting lighting fixture becomes a safety hazard often presented with other light shield. adapters. The invention described in this application alleviates this issue by including twelve IDA-compliant heat vents that help to disperse the heat energy while also creating a more desirable and natural light output pattern.

Another issue across other light bulb adapters is the problem with light pattern and lux output. Many light shield adapters limit the amount of light to within the IDA standards, but end up being on the low end of the IDA standards. If a homeowner doesn't receive enough light onto their property, then it could lead to potential neighborhood safety hazards. The more light your neighborhood has at night, the more obstacles for a potential burglar. This invention stays within the IDA standards while also being on the upper boundary of lumen output allowed. Therefore, the user is getting the maximum amount of light output that would be allowed under the IDA.

This adapter addresses the problem that whole communities may face in becoming IDA compliant upon local/national/international regulatory mandated guidelines, requiring limited vertical light emission. It enables all homeowners regardless of economic status to become compliant with such mandates. By retrofitting this adapter, asteroid detection telescopes will be better enabled to help detect potentially catastrophic asteroids.

### BRIEF DESCRIPTION OF THE SEVERAL VIEWS OF THE DRAWING

These and other details of my invention will be described in connection with the accompanying drawings, which are furnished only by way of illustration and not in limitation of the invention. Those skilled in the art will understand that the drawings, described herein, are for illustration purposes only. The drawings are not intended to limit the scope of the present disclosure:

FIG. 1A shows an isometric view, exposing the bottom half of the proposed invention.

FIG. 1B shows a direct front view of the cylindrical outer bulb cover of the present invention having a hollow body and evenly spaced vents.

FIG. 1C shows the 180 Degree rotation of FIG. 1B to show an alternate view.

FIG. 1D shows an overhead view of the proposed invention, allowing for a view of the circular light bulb interface.

FIG. 1E shows a rotated isometric view showing the top of the cylindrical body, exposing the surface cover with light bulb interface circle. This circular opening ensures a fitted interface between the light bulb and the socket base while also ensuring a comfortable fit and placement for the invention therein.

FIG. 1F shows the proposed invention as it would be used as a consumer product. A standard commercial light bulb enters the bottom half of the proposed invention and interfaces with the circular light bulb interface shown in FIG. 1D.

FIG. 1G shows the final view of the proposed invention body properly interfaced with the light bulb. The exposed light bulb base at the top of the body is then fitted to the proper light bulb socket base, wherein the entire component (light bulb and invention combination) is properly and tightly secured in place via the socket base.

FIGS. 1A-E show the proposed invention in which a hollow extended cylindrical body is illustrated with the added visual of a standard light bulb. FIGS. 1A-E show different perspective views of the invention, allowing for a visual that encompasses the entire appearance. FIGS. 1F and 1G show proposed invention consumer use with a standard light bulb. All seven figures represent the same body used/angled for different scenarios. The features disclosed in the invention are not limited to the current drawings, detailed description, and content.

### DETAILED DESCRIPTION OF THE INVENTION

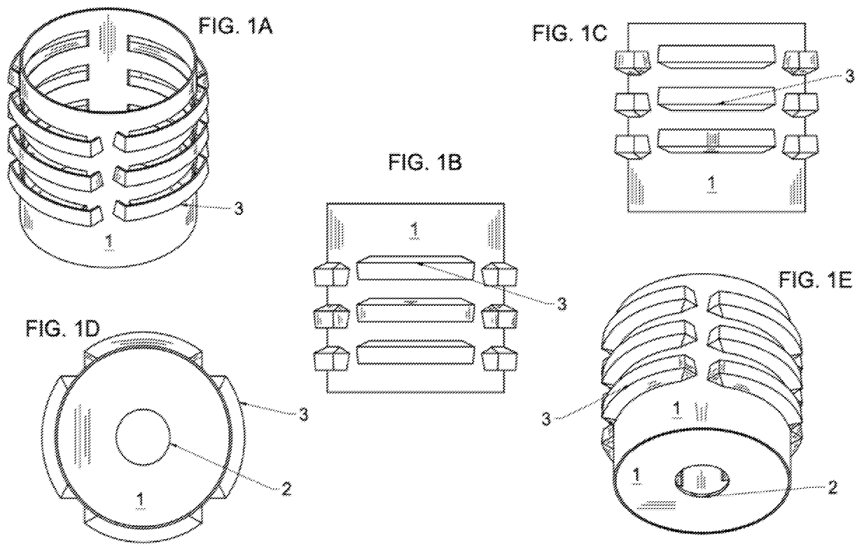

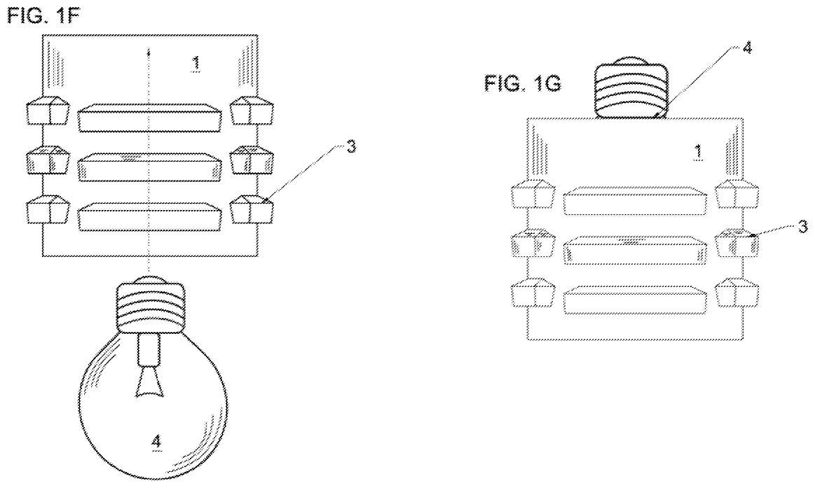

The unique invention described in this patent relates to a cylindrical body having capabilities to interface with a standard light bulb and light bulb socket. As the light bulb 4 is properly fitted into the light bulb socket via the invention, it securely holds the invention in place. The current invention is in the form of a single-unit uniform heat-resistant plastic. FIGS. 1A-E show many different perspective angles/views of the current invention. The embodiment shown in FIG. 1A-E contain the main outer body unit 1, the circular opening on the top that interfaces with a standard light bulb 2, and the venting system consisting of twelve fully shielded vents 3. As shown in FIG. 1F and 1G, the circular opening 2 properly interfaces with a standard light bulb 4, wherein said light bulb is still able to be turned on after screwing the light bulb/invention combination into a light bulb socket. As shown in FIG. 1G, the invention completely hides the light bulb 4 from direct outside view. This has to remain true in order for the invention to be compliant by the International Dark Sky Association (IDA) standards. Similarly, in FIG. 1G, any view of the light source disqualifies it from being IDA compliant and so the vents completely shield the light source from both the front view and the side views, properly directing the light source downward. As shown in FIG. 1A-G, there is no assembly required for this invention. The consumer requires only the light bulb shield unit and a standard light bulb. Assembly consists of placing the light bulb 4 into the invention housing 1, inserting the bulb through the circular opening 2, and finally inserting the bulb again into the desired light bulb socket to turn on the light bulb. Finally, the user's carriage lantern of their choice is placed over the light bulb shield to fully modify their house light into a better shielded house light. The current invention should not be limited by the current drawings, detailed description, and that modifications and variations may still fall within the scope of the current invention.

### SEQUENCE LISTING

Not Applicable.

I claim:

1. An outdoor lighting fixture adapter module, comprising a hollow cylinder-shaped body (that fully covers the light bulb) with dissipating heat vents and a circular opening fitted for the threaded base of a standard commercial light bulb (recommended CFL or LED).

2. The device of claim 1 wherein the outdoor lighting fixture adapter module is held in place only by the light bulb and light bulb socket interface, and not by any sort of bracket or clamping system.

3. The device of claim 1 wherein the top of the hollow cylinder body has a base having a peripheral edge at the top end opening of the hollow body portion encompassing a mating interior threaded opening so that the hollow body portion reversibly screws onto and off of the base of a standard light bulb (recommended CFL or LED).

4. A hollow cylinder-shaped adapter module as claimed in claim 1, manufactured from a thermoplastic-based material that is durable, wear resistant, UV-resistant, lightweight, and compatible in both hot and cold environments.

5. An adapter as claimed in claim 1, further comprising of twelve heat-dissipating vents that allow for both the dissipation of light bulb heat and acceptable light transmission to more effectively illuminate the ground below.

6. A group of twelve heat vents as claimed in claim 5, wherein said heat vents are dark sky compliant and effectively contribute to a more desired illumination pattern and higher acceptable light output.

7. A group of twelve heat vents as claimed in claim 6, wherein said heat vents allow increased light output while also permitting no more than 10 lumens between the angles of 90-100 degrees and no more than 50 lumens between the angles of 90-180 degrees (current IDA standards).
